(19) United States
(12) Patent Application Publication
(10) Pub. No.: US 2024/0152371 A1
(43) Pub. Date: May 9, 2024

(54) DYNAMIC RE-EXECUTION OF PARTS OF A CONTAINERIZED APPLICATION PIPELINE

(71) Applicant: INTERNATIONAL BUSINESS MACHINES CORPORATION, Armonk, NY (US)

(72) Inventors: Jin Chi He, Xian (CN); Guang Han Sui, Beijing (CN); Gang Pu, Xian (CN); Zhan Wei Wang, Xian (CN); Peng Li, Xian (CN); Gang Wang, Xian (CN)

(21) Appl. No.: 17/980,650

(22) Filed: Nov. 4, 2022

(51) Int. Cl. G06F 9/455

(52) U.S. Cl. CPC G06F 9/45558; G06F 2009/4557

(57) ABSTRACT

A method including: storing results of a task in a pipeline executed in a container running in a computing environment; generating a check point for the task; and re-executing the pipeline from the check point for the task reusing the results.

### BACKGROUND

Aspects of the present invention relate generally to containerized application pipelines and, more particularly, to managing execution of containerized application pipelines.

A container is a stand-alone executable package of a piece of software that includes everything needed to run it, including application code, runtime, system tools, system libraries, and settings. Containers are lightweight and constructed from layered filesystems, e.g., sharing common files, making disk usage and image downloads efficient. A container can run in various environments including but not limited to a local computing device (e.g., a desktop or a laptop), physical or virtual machines in a data center, and cloud providers.

Containers provide lightweight virtualization that allows for isolating processes and/or resources without the need of providing instruction interpretation mechanisms and/or other complexities of full virtualization. Container technology provides lightweight virtualization that allows isolating processes and resources without the need to provide instruction interpretation mechanisms and other complexities of full virtualization. Containers effectively partition the resources managed by a single host operating system (OS) into isolated groups to better balance the conflicting demands on resource usage between the isolated groups. That is, the container technology allows sharing a common OS and possibly some appropriate binary files or libraries. As such, plural containers can run simultaneously on a same computer device, each sharing the same OS kernel of the computer device and each running as an isolated process in user space.

Containers differ from virtual machines (VMs) in the sense that VMs are an abstraction of physical hardware effectively turning one server into plural servers, with a hypervisor controlling the plural VMs running on a single machine. Each VM includes a full copy of an OS, one or more applications, and any necessary binaries and libraries. Containers typically take up less storage space than VMs and start (e.g., boot) faster than VMs.

Containerized application pipelines include sets of tasks run in a particular order. These containerized application pipelines allow for isolation between pipelines and subsequently the tasks of the pipelines. Each task of the pipelines runs off a container image which includes all the dependencies needed for the application.

### SUMMARY

In a first aspect of the invention, there is a computer-implemented method including: storing, by a processor set, results of a task in a pipeline executed in a container; generating, by the processor set, a check point for the task; and re-execute, by the processor set, the pipeline from the check point for the task reusing the results.

In another aspect of the invention, there is a computer program product including one or more computer readable storage media having program instructions collectively stored on the one or more computer readable storage media. The program instructions are executable to: store results of a task in a pipeline executed in a container; setting a start task of the pipeline based on the results of the task; and re-execute the pipeline from the start task of the pipeline.

In another aspect of the invention, there is system including a processor set, one or more computer readable storage media, and program instructions collectively stored on the one or more computer readable storage media. The program instructions are executable to: store results of a task in a pipeline executed in a container; generate a check point for the task; and generate a template pipeline to re-execute the pipeline from the check point for the task reusing the results.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows a flowchart of an exemplary method in accordance with aspects of the invention.

FIG. 4A shows a flowchart of an exemplary pipeline for which aspects of the invention may be a solution.

FIG. 4B shows a flowchart of an exemplary pipeline for which aspects of the invention may be a solution.

FIG. 4C shows a flowchart of an exemplary pipeline for which aspects of the invention may be a solution.

FIG. 5 shows a cluster architecture of an exemplary re-execution (i.e., rerun) hook in accordance with aspects of the invention.

FIG. 6 shows a flowchart of an exemplary re-execution hook mechanism process in accordance with aspects of the invention.

FIG. 7 shows a flowchart of an exemplary results storage process in accordance with aspects of the invention.

FIG. 8 shows a flowchart of an exemplary check point setting process in accordance with aspects of the invention.

FIG. 9A shows a flowchart of an exemplary start and end point setting process in accordance with aspects of the invention.

FIG. 9B shows a flowchart of an exemplary virtual task generation process in accordance with aspects of the invention.

FIG. 10 shows a flowchart of an exemplary task failure re-execution process in accordance with aspects of the invention.

FIG. 11 shows a flowchart of an exemplary re-execution process in accordance with aspects of the invention.

### DETAILED DESCRIPTION

Aspects of the present invention relate generally to containerized application pipelines and, more particularly, to managing execution of containerized application pipelines. In embodiments, there is a system comprising a dynamic re-execution of a pipeline device that manages re-execution of interested parts of a containerized application pipeline. In this manner, implementations of the invention allow pipelines of a container to be partially re-executed instead of re-executing the pipeline in its entirety.

In one embodiment, a method and component rerun hook triggers re-execution of the pipeline inside of a container. The method and component are used to monitor custom logic and take pre-actions before re-execution of a pipeline inside of a container. The method and component store the status/results of tasks in the pipeline of the container and reuse previous statuses and/or results based on various strategies. In one embodiment, the method dynamically re-executes a part of the pipeline on a cloud system.

In aspects of the invention there is a method providing a module to re-execute custom logical inside of a container. The method may include a step wherein a component rerun hook triggers re-execution inside of the container. The method may include a step of monitoring the custom logical and taking pr-actions before re-execution inside the container. The method may include a step of storing the status/results of the container and reusing previous status/results based on strategies. The method may include a step of dynamically re-executing on the pipeline level on a cloud.

In current implementations of containerized application pipelines, failed tasks require the entire pipeline to be re-executed even though restarting the execution of the pipeline may not resolve the failed task. In some rare instances, network or environment issues may cause low-probability failures where re-execution may be successful; however, numerous failures to the file system, host/node failures, and network will not be successful and re-execution of the entire pipeline will be a waste of resources. Because in containerized applications there are no dependencies between pipeline tasks of each container, even if these containers are run on the same node (e.g., host device), each pipeline is executed in full (i.e., from starting task to finish or starting task until failure). In other words, pipelines are not executed from a midpoint task in the pipeline, from a task that had failed during the pipeline execution, or end at a midpoint task (i.e., end task) in the pipeline. Thus, a dynamic re-execution of a portion of a pipeline is needed. Thus, a technical problem with utilization of containerized application pipelines is due to the inability to execute a pipeline from a midpoint in the pipeline. The present invention provides a technical solution to this problem by storing results for each task in a pipeline for use in dynamic re-execution of a pipeline from a check point. In particular, the dynamic re-execution of a part of the pipeline reduces the costs of re-execution by only executing the interested part of the pipeline. In this manner, implementations of the invention provide a technical improvement to managing execution of containerized application pipelines.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamic re-execution of an interested part of a containerized application pipeline code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

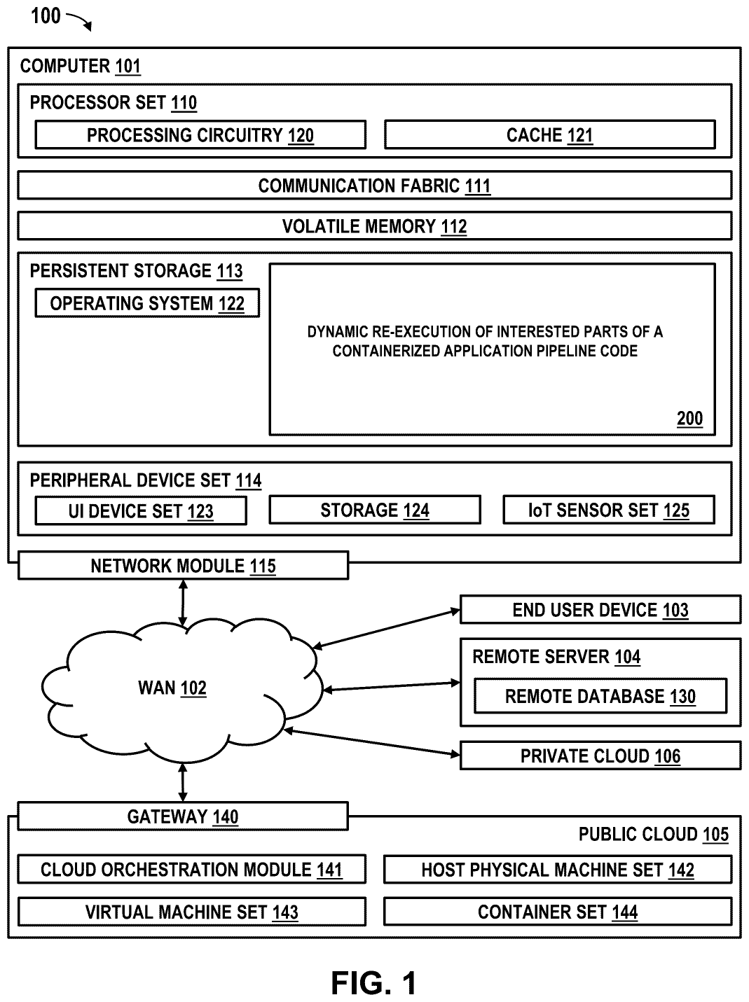

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

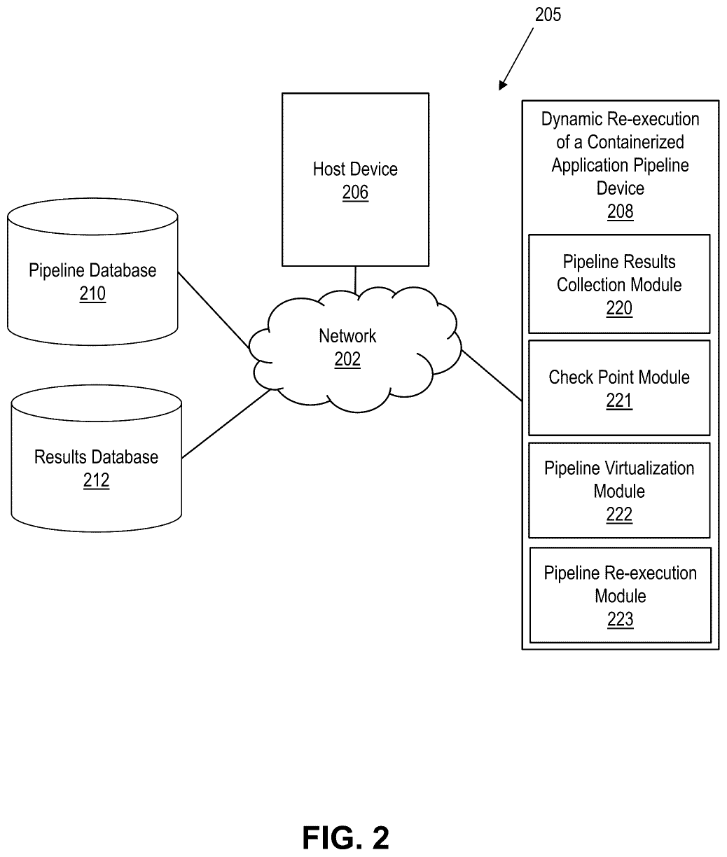

FIG. 2 shows a block diagram of an exemplary environment 205 in accordance with aspects of the invention. In embodiments, the environment 205 includes a network 202 enabling communication between host device 206, dynamic re-execution of a pipeline device 208, pipeline database 210, and results database 212. In some embodiments, the host device 206 and dynamic re-execution of a pipeline device 208 of FIG. 2 may correspond to the client computer 101 of FIG. 1. In other embodiments, the host device 206 may correspond to an end user device 103 of FIG. 1 that includes a container running one or more applications and the dynamic re-execution of a pipeline device 208 may correspond to the client computer 101 of FIG. 1.

In embodiments, the dynamic re-execution of a pipeline device 208 of FIG. 2 comprises a pipeline results collection module 220, a check point module 221, a pipeline virtualization module 222, and a pipeline re-execution module 223, each of which may comprise modules of the code of block 200 of FIG. 1. These modules of the code of block 200 are executable by the processing circuitry 120 of FIG. 1 to perform the inventive methods as described herein. The dynamic re-execution of a pipeline device 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the pipeline results collection module 220 is configured to collect results of each task including build variables, image information, commands, and/or other special user definitions based on their labels or specifications. The image information may include information about the container image such as image names and tags. The commands and special user definitions may include runtime commands and special user definitions that manage/create/run the containers. The results of the tasks may be hashed, for example using SHA256 to provide a key value for the task results. These results may be stored in the results database 212 as associated with its own task. Information about the pipeline and each task of the pipeline may be stored in the pipeline database 210 and may be associated with its related result of the results database 212.

In embodiments, the check point module 221 is configured to determine or retrieve a check point setting for the re-executions of the pipeline. The check point may be determined based on events or interest in a particular task of the pipeline. In exemplary embodiments, the check point may be determined based on monitored tasks that have failed in the pipeline. In exemplary embodiments, the check point may by a user selected task. In exemplary embodiments, both the start and end point in the tasks of the pipeline may be set.

In embodiments, the pipeline virtualization module 222 is configured to generate a virtual task that replaces the task results up to the task that is the check point. This virtual task acts as a start task for a template pipeline that allows reuse of the results of previous tasks and does not require re-execution of the pipeline as a whole. The template pipeline may include an enhanced record of tasks of the pipeline, name for the tasks, and results of each task as stored in the pipeline database 210 and results database 212. In exemplary embodiments, the pipeline virtualization module 222 creates this virtual task, then suspends the original pipeline and creates the template pipeline. In exemplary embodiments, the pipeline virtualization module 222 also updates the original pipeline results with template results once the template pipeline is finished re-executing. In one example, the template results are the re-executed results of the tasks in the template pipeline. In exemplary embodiments, the virtual tasks and template pipeline are created in the container for re-execution.

In embodiments, the pipeline re-execution module 223 is configured to determine a strategy involved in the re-execution of a part of the pipeline. These strategies may be included in a configMap. The strategies may include the effects of task failure, user selected starting and ending point tasks, user selected branch tasks, along with information about whether re-execution is available for a particular pipeline, label(s) for the pipeline, how many retries before a task is deemed failed, and how and what results are stored. In exemplary embodiments, failure includes tasks being retried a predetermined threshold number of times, system failures such as network failures, host/node failure, or file system failures, among others.

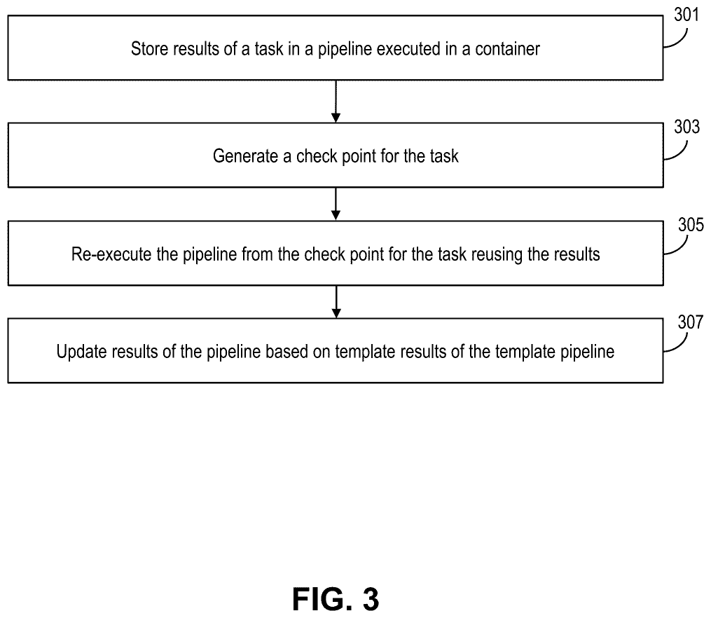

FIG. 3 shows a flowchart of an exemplary method in accordance with aspects of the present invention. Steps of the method may be carried out in the environment of FIG. 2 and are described with reference to elements depicted in FIG. 2.

At step 301, the dynamic re-execution of a pipeline device 208 of FIG. 2 stores results of a task in a pipeline executed in a container. In embodiments, and as described with respect to FIG. 2, these results may be stored in results database 212. The results may include image name and tag, build variables, commands, and other user special definitions and labels that are associated with the task of the pipeline. The build variables may include args and env variables that are sorted for storage. The args variables are only available during the build of the image and not after the image is created. Args variables may be used to set env variables. In contrast env variables (i.e., environment variables) are available to containers during the build starting with the line of introduction. In exemplary embodiments, handling each of the args variables and env variables includes sorting each into their own category (args variable or env variable) for storage as results of a task in the pipeline. In exemplary embodiments, the results (i.e., values) and inputs (i.e., keys), are hashed and stored in results database 212. Once the container is finished executing the latest results are stored based on strategy configuration. For example, a failed task may include results set to a predetermined number to distinguish from the original correct results of each task in the pipeline. The hashed results of a check point task (as stored in the results database 212) may be used to compare/match check point task results (non-hashed) again to verify that the results remain the same. In an exemplary embodiment, the results database 212 does not need to retain the results of each task (this information may instead be stored in the pipeline database 210 as non-hashed results of a task) instead, the results database 212 only stores the hashed results.

At step 303, the dynamic re-execution of a pipeline device 208 of FIG. 2 generates a check point for the task. In embodiments, and as described with respect to FIG. 2, the check point may be defined by the user or automatically generated by the system based on rules. These rules may be defined by the user or system and may include, for example, points of interest in the pipeline including long tasks (based on time of execution), a large output is generated by the task, an unusual task, and/or a specified number of tasks are finished in the pipeline (e.g., 100 tasks). During the re-execution the check point task reuses the original results from the check point task for use in the continued re-execution of subsequent tasks in the pipeline (i.e., tasks that occur after the check point task).

At step 305, the dynamic re-execution of a pipeline device 208 of FIG. 2 re-executes the pipeline from the check point for the task. In embodiments, and as described with respect to FIG. 2, the re-execution starts with the check point and either continues until the remaining tasks are done or continues to a set stopping point. Once the check point is generated (i.e., selected), the dynamic re-execution of a containerized application pipeline device 208 re-executes the portion of the pipeline after the check point using the results of the check point.

At step 307, the dynamic re-execution of a pipeline device 208 of FIG. 2 updates results of the pipeline based on results (i.e., template results) of the re-executed portion of the pipeline (i.e., the template pipeline). In embodiments, and as described with respect to FIG. 2, the updating of the results prevents the need to re-execute the entire pipeline by replacing the original pipeline results with the template results of the re-execution portion of the pipeline.

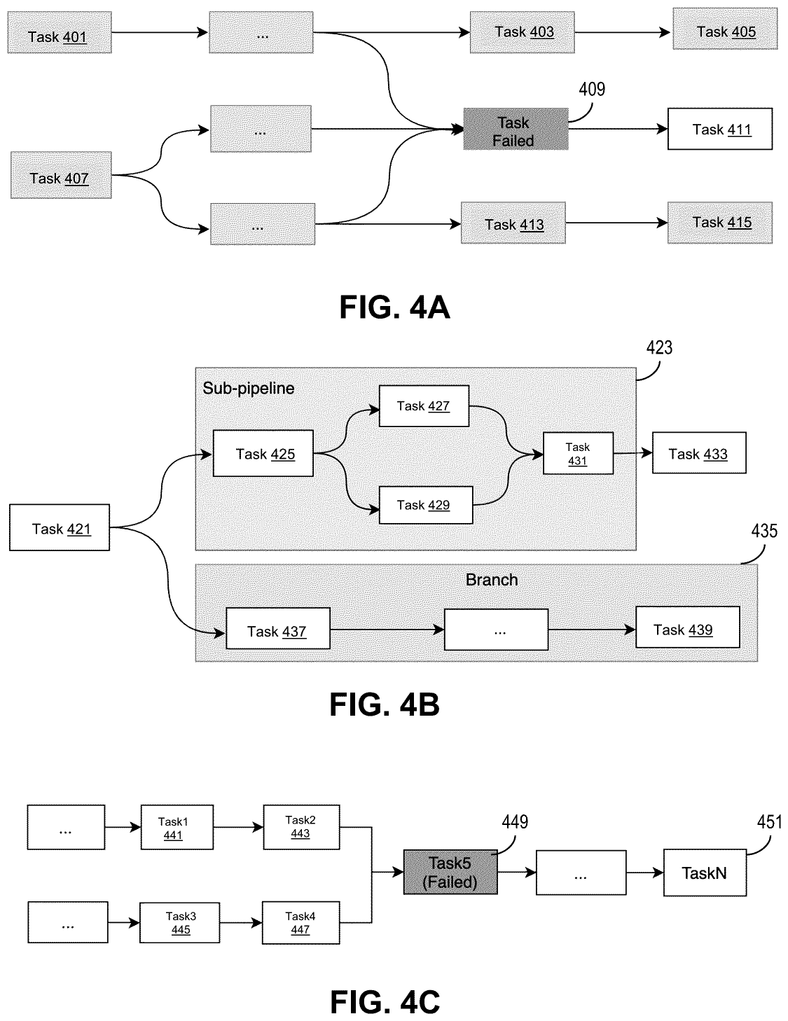

FIG. 4A shows a flowchart of an exemplary pipeline for which aspects of the invention may be a solution. Containerized application pipelines include sets of tasks run in a particular order in the container to execute containerized application pipelines where the set of tasks are defined by the pipeline to streamline the process of application development. This flowchart includes many tasks (i.e., 401-415) in the pipeline. This flowchart involves more complex pipelines where a plurality of task results (such as results from tasks 401 and 407) may be used in a failed task 409 and/or tasks may be connected in complex ways (e.g., web-like connections). This added complexity to the pipeline may result in a re-execution of the pipeline that may take a long time or even may not be allowed to be re-executed. Starting from the first task in the pipeline may require a lot of resources.

FIG. 4B shows a flowchart of an exemplary pipeline for which aspects of the invention may be a solution. This flowchart includes many tasks (i.e., 421-439) in the pipeline. This flowchart involves pipelines with sub-pipelines 423 or branches 435. These sub-pipelines and branches add complexity and may easily be separated from the original/main pipeline. One example of a sub-pipeline might be machine learning model loops.

FIG. 4C shows a flowchart of an exemplary pipeline for which aspects of the invention may be a solution. This flowchart includes many tasks (i.e., 441-451) in the pipeline. A user may define when the re-execution will occur and how the re-execution occurs. Since Task5 449 failed in FIG. 4C, a user may want to re-execute the pipeline from Task2 443 or Task4 447. Re-executing the pipeline from the beginning would take too long and/or a user may wish to request re-execution for the most updated results.

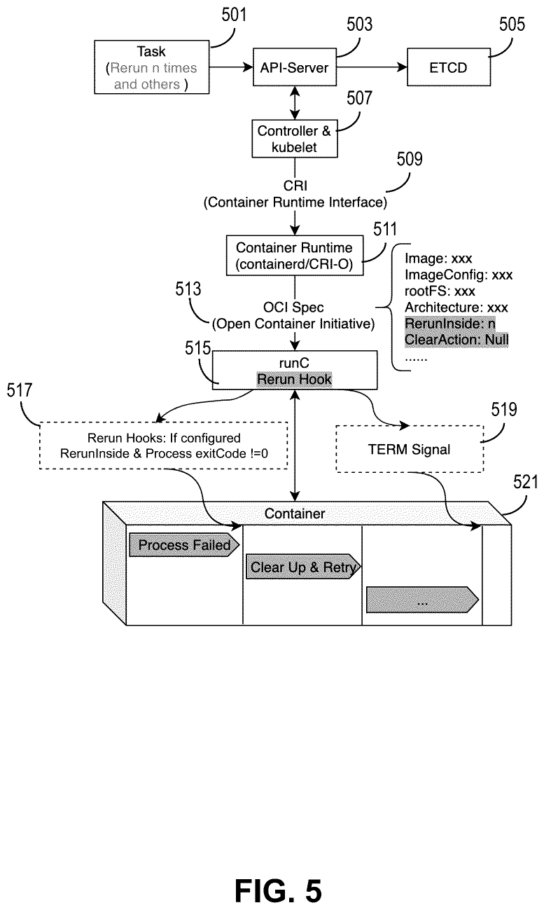

FIG. 5 shows a cluster architecture of an exemplary re-execution (i.e., rerun) hook in accordance with aspects of the invention. Steps of the method may be carried out in the environment of FIG. 2 and are described with reference to elements depicted in FIG. 2. The cluster architecture includes the task 501 at hand that may be re-executed n-times, an application programming interface (API) server 503, a distributed reliable key-value store (i.e., etcd) 505, controller 507, container runtime interface (CRI) 511, open container initiative (OCI) specification 513, the runtime (runC) 515 (including the rerun hook 517 and termination (TERM) signal 519), and container 521 itself. In exemplary embodiments, the API server 503 allows query and manipulation of containers. In exemplary embodiments, the ETCD 505 is a strongly consistent, distributed key-value store that provides a reliable way to store data that needs to be accessed by a distributed system or cluster of machines. The ETCD 505 provides a way to notify hosts/users of changes to the stored key-values. In exemplary embodiments, the controller 507 may include the dynamic re-execution of a pipeline device 208 of FIG. 2. The controller 507 includes a control loop that monitors the state of the cluster, then makes changes to push the cluster toward the desired state. In exemplary embodiments, the CRI 509 allows use of a wide variety of container runtimes without the need to recompile the cluster components. In exemplary embodiments, the CRI-O 511 is a particular implementation of the CRI that allows the CRI to manage and launch OCI 513 containers. In embodiments, the CRI-O pulls images, manages storage and networking, and supervises the running (i.e., execution) of containers. RunC 515 is part of the OCI 513 and allows runtime implementations running OCI-compliant bundles and container configurations. RunC 515 executes the rerun hook 517 and termination (TERM) signal 519 in container 521. In embodiments, runC 515 implements low-level container runtime commands that manage/create/run the containers.

In exemplary embodiments, rerun hook 517 is a component in runC and is used to monitor the container and user entry point. The rerun hook is a customized programming code that includes the code to execute a rerun of the pipeline at a check point. If exit code of the custom process is not 0, the user process may be re-executed automatically with clear up and retry actions and strategies.

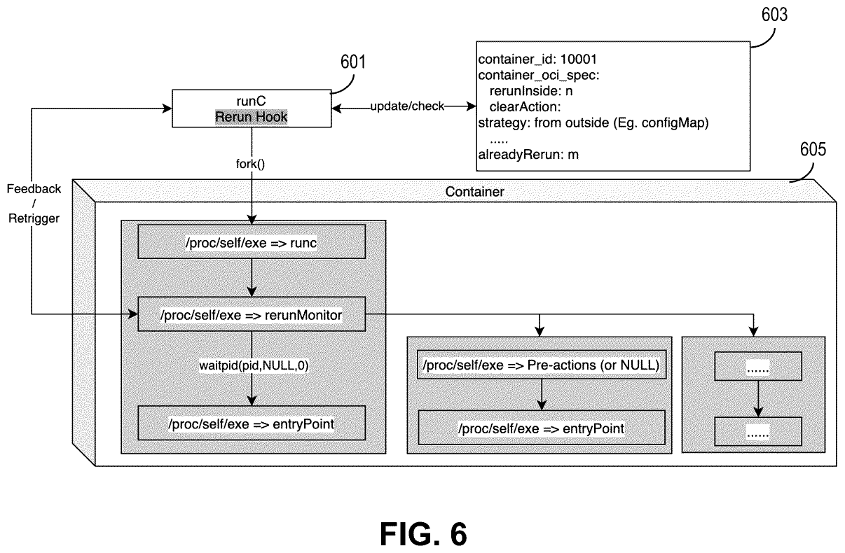

FIG. 6 shows a flowchart of an exemplary rerun (also referred to as a re-execution) hook mechanism process in accordance with aspects of the invention. Steps of the method may be carried out in the environment of FIG. 2 and are described with reference to elements depicted in FIG. 2. In embodiments, the runtime pipeline re-execution module 223 of FIG. 2 may be utilized to process each of the steps in the re-execution hook mechanism process flowchart. In exemplary embodiments, the runC rerun hook 601 begins a rerunMonitor to monitor the pipeline and provide feedback/triggering of the runC rerun hook. The rerun hook will check and generate pre-actions based on strategies. For example, to fix platform errors the rerun hook will attempt to resolve the platform errors before re-executing the interested portion of the pipeline. The interested portion of the pipeline may include a task in the pipeline that failed to provide a result or just a user predefined check point of interest where more host device resources are used. The runC rerun hook 601 also updates/checks pipeline information 603 such as a container id. The runC rerun hook 601, rerunMonitor, and pre-actions are executed within container 605.

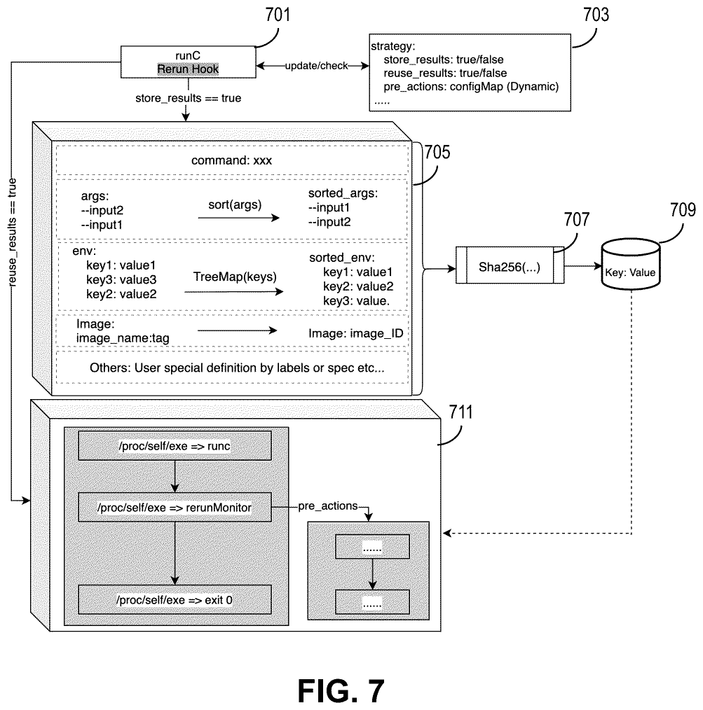

FIG. 7 shows a flowchart of an exemplary results storage process in accordance with aspects of the invention. Steps of the method may be carried out in the environment of FIG. 2 and are described with reference to elements depicted in FIG. 2. In embodiments, the pipeline results collection module 220 of FIG. 2 may be utilized to process each of the steps in the results storage process flowchart as further described in step 301 of FIG. 3. The storage process including the runC 701, strategy 703 (i.e., task variables) where task results are sorted 705 and hashed using sha256 707 to get inputs and results that are capable of being reused. In exemplary embodiments, once the hashing 707 is done, the key:value is stored in 709 which may include the results database 212 of FIG. 2. Once the pipeline is finished in container 711, the latest results are stored to results database for reuse. The strategy 703 including a sorting of args variables, a treemap sorting the key:value pairs of the env variables, and images tracked with an image identifier.

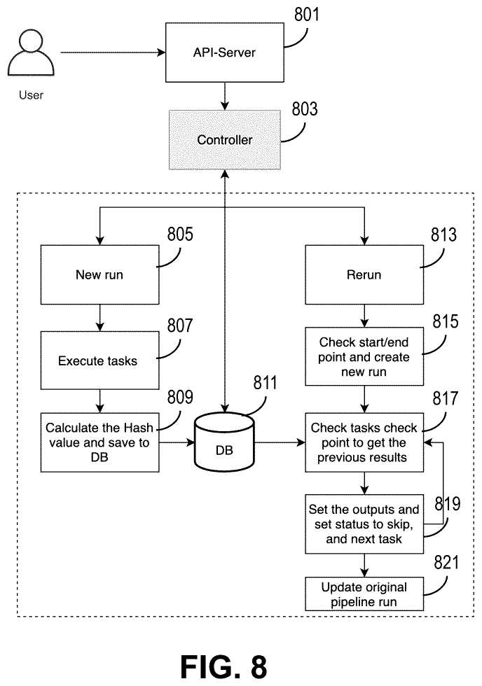

FIG. 8 shows a flowchart of an exemplary check point setting (i.e., generating) process in accordance with aspects of the invention. Steps of the method may be carried out in the environment of FIG. 2 and are described with reference to elements depicted in FIG. 2 and further described in step 303 of FIG. 3. In embodiments, the check point module 221 of FIG. 2 may be utilized to process each of the steps in the check point setting process flowchart. As shown, a user interacts with the API-server 801 and subsequently the controller 803. The controller determines when to execute a new run 805 of the pipeline, re-execute 813 the pipeline, and what information may be stored in database (DB) 811. In a new run 805, the controller 803. Once the new run has begun, tasks in the pipeline are executed 807 (i.e., execute tasks) and results. Calculate hash values 809 for the results and storing the results and/or hashed results in results database 811. The hash values 809 may be compared against another computed hash value of the check point(s) to verify that results of the check point are correct. When re-execution 813 is selected, the start and end points are checked to create a new run815. To further determine when and where to rerun (i.e., which task to begin the rerun) 817. The previous results near the pipeline provide a starting point for the check point tasks. Once the check point is set, results (including output and status) for the next task 819 are collected. These results for the next task 819 are used to update the original pipeline run results 821.

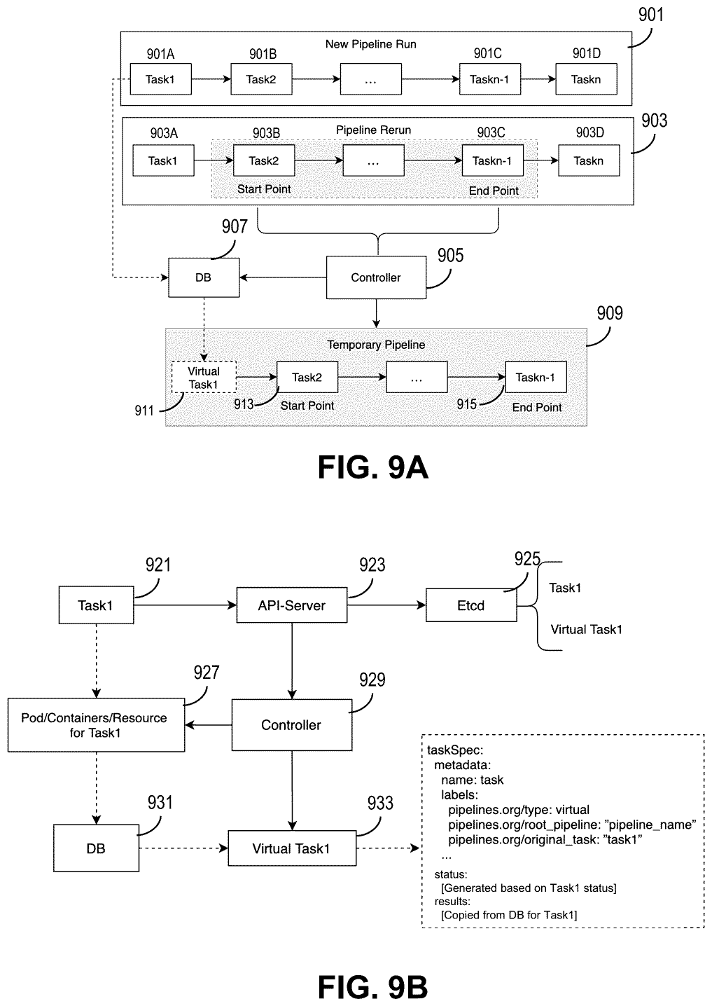

FIG. 9A shows a flowchart of an exemplary start and end point setting process in accordance with aspects of the invention. Steps of the method may be carried out in the environment of FIG. 2 and are described with reference to elements depicted in FIG. 2 and further described in step 303 of FIG. 3. In embodiments, the check point module 221 of FIG. 2 may be utilized to process each of the steps in the start and end point setting process flowchart. The flowchart including the new pipeline run 901 (and tasks 901A-D) and pipeline rerun 903 (and tasks 903A-D). Where controller 905 is used to set the start point 903B and end point 903C of the pipeline that is of interest. The results of task1 901A (the original results) have been stored in database DB 907 and the original results are reused in the virtual task1 911 to act as a starting point for the template pipeline 909. The start point being task2 913 and end point taskn−1 915. Once the template pipeline is executed the controller 905 may update the results of task2 901B and taskn−1 901C as further described in step 307 of FIG. 3.

FIG. 9B shows a flowchart of an exemplary virtual task generation process in accordance with aspects of the invention. Steps of the method may be carried out in the environment of FIG. 2 and are described with reference to elements depicted in FIG. 2. In embodiments, the pipeline virtualization module 221 of FIG. 2 may be utilized to process each of the steps in the virtual task generation process flowchart. In embodiments, virtual task1 933 is generated in order to reuse original and/or past results. Containers 927 do not need to be started for resource allocation. Again, ETCD 925 collects and stores information about task1 921 and virtual task1 933. The task1 921 is run on API server 923 and task1 921 is a part of container 927. The task1 921 results may be stored in the database DB 931 and reused by virtual task1 933.

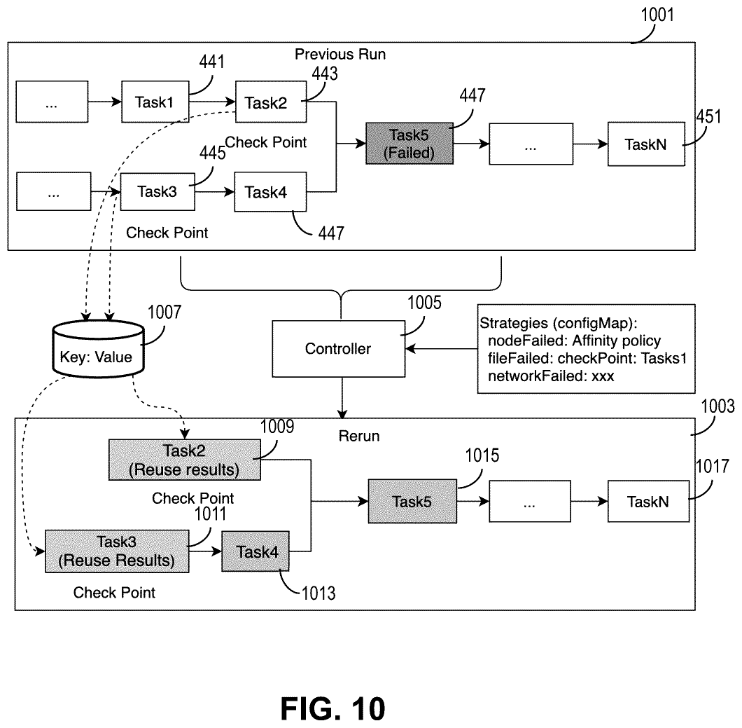

FIG. 10 shows a flowchart of an exemplary task failure re-execution process in accordance with aspects of the invention. Steps of the method may be carried out in the environment of FIG. 2 and are described with reference to elements depicted in FIG. 2 and further described in step 303 of FIG. 3. In embodiments, the pipeline re-execution module 223 and pipeline virtualization module 222 of FIG. 2 may be utilized to process each of the steps in the task failure re-execution process flowchart. For example, the initial execution (i.e., run) of the pipeline 1001 includes a failure at task5 449 from FIG. 4C. Task2 443 and task3 445 are deemed check points and their results are stored in key:value database 1007 (i.e., results database 212 of FIG. 2). These results are used by controller 1005 to establish the template pipeline that is utilized for re-execution of the interested part of the original pipeline from FIG. 4. The controller 1005 including strategies for failure where one or more check points are selected that occur before the failure at task5 449. In the aspect of the invention shown in FIG. 10, task4 447 may not be selected as a check point because it may have been a short task that required fewer resources to execute. Thus, because task2 443 and task3 445 are executed before task5 449, the results from these tasks are reused in the re-execution of the interested part of the pipeline (i.e., the part of the pipeline with the failed task). These results, in exemplary embodiments, may be utilized in generated virtual tasks as described in FIG. 9B above. Thus, the newly re-executed part of the pipeline begins with the virtual tasks of task2 1009 and task3 1011 that were check points. Task4 1013 is re-executed (as shown in FIG. 10) or results for task4 447 may be collected from the key:value database 1007. And task5 1015 is re-executed without failure and the pipeline continues to be re-executed until ending task taskn 1017.

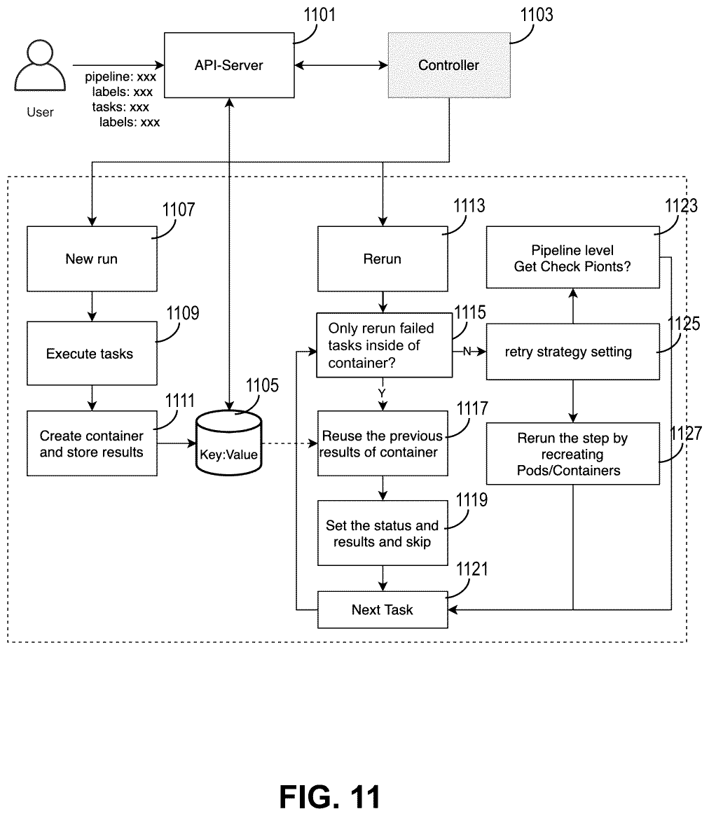

FIG. 11 shows a flowchart of an exemplary re-execution process in accordance with aspects of the invention. Steps of the method may be carried out in the environment of FIG. 2 and are described with reference to elements depicted in FIG. 2. In embodiments, the pipeline re-execution module 223 of FIG. 2 may be utilized to process each of the steps in the re-execution process flowchart. In exemplary embodiments, the controller 1103 receives resource definitions from the API-server 1101. These resource definitions may include pipeline information such as labels and tasks (and the labels for the tasks) that may be stored in pipeline database 210. The controller 1103 may execute the initial (i.e., new run) of the pipeline 1107 and executes each of the tasks 1109 in the pipeline to create the container 1111 and store results of each of the tasks in the key:value database 1105.

Upon failure of tasks, the controller 1103 includes strategies to re-execute 1113 the failed task part of the pipeline. The controller 1103 may determine 1115 whether only the tasks selected (after the check point) include tasks effected by the failed task. If the re-execution is determined to only include tasks effected by the failed task (not including the check point(s)). Then results from the check point tasks may be reused 1117 and taken from the key:value database 1105. With those results, the status of the check point task may be set 1119 to skip the re-execution of the check point task and the next task 1121 (i.e., commonly the failed task). If, however, it is determined that the re-execution strategy results in more tasks than the failed tasks, the re-execution strategy may need to be updated and/or changed and retried 1125. Once retried, the check point is again set 1123 and will instead include only the failed tasks (after the check point task) and the re-execution can continue as normal to the next task 1121. Further, the re-execution of the task may be through recreation of the container 1127. In exemplary embodiments, for failed tasks, the status labels for the task may be set to include results of the task and whether these results are correct (i.e., for non-failed tasks) and whether the failure is from an event inside or outside the container.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
storing, by a processor set, results of a task in a pipeline executed in a container running in a computing environment;
generating, by the processer set, a check point for the task; and
re-executing, by the processor set, the pipeline from the check point for the task.

2. The method of claim 1, further comprising:
determining another task in the pipeline failed during execution of the pipeline; and
re-executing the pipeline from the determined another task.

3. The method of claim 1, wherein the storing results includes:
retrieving image information based on image name and/or tag;
handling environment variables; and
computing a hash value for a command, the image information, and the environment variables of the task.

4. The method of claim 3, further comprising:
comparing the hash value to another computed hash value of the check point.

5. The method of claim 1, further comprising:
generating a template pipeline to re-execute the pipeline.

6. The method of claim 5, further comprising:
updating the results of the pipeline based on template results of the template pipeline.

7. The method of claim 5, further comprising:
generating a virtual task with results of the check point to start the template pipeline.

8. The method of claim 1, further comprising:
setting a start task of the pipeline based on the check point.

9. The method of claim 1, further comprising:
setting an end task of the pipeline based on a user selection.

10. A computer program product comprising one or more computer readable storage media having program instructions collectively stored on the one or more computer readable storage media, the program instructions executable to:
store results of a task in a pipeline executed in a container running in a computing environment;
set a start task of the pipeline based on the results of the task; and
re-execute the pipeline from the start task of the pipeline reusing the results.

11. The computer program product of claim 10, wherein the program instructions are executable to:
determine another task in the pipeline failed during execution of the pipeline; and
re-execute the pipeline from the determined another task.

12. The computer program product of claim 10, wherein the program instructions are executable to:
retrieve image information based on image name and/or tag;
handle environment variables; and
compute a hash value for a command, the image information, and the environment variables of the task.

13. The computer program product of claim 12, wherein the program instructions are executable to:
comparing the hash value to another computed hash value of the check point.

14. The computer program product of claim 10, wherein the program instructions are executable to:
generate a template pipeline to re-execute the pipeline.

15. The computer program product of claim 14, wherein the program instructions are executable to:
update the results of the pipeline based on template results of the template pipeline.

16. The computer program product of claim 14, wherein the program instructions are executable to:
generate a virtual task with results of the check point to start the template pipeline.

17. A system comprising:
a processor set, one or more computer readable storage media, and program instructions collectively stored on the one or more computer readable storage media, the program instructions executable to:
store results of a task in a pipeline executed in a container running in a computing environment;
generate a check point for the task; and
generate a template pipeline to re-execute the pipeline from the check point for the task reusing the results.

18. The system of claim 17, wherein the program instructions are executable to:
determine another task in the pipeline failed during execution of the pipeline; and
re-execute the pipeline from the determined another task.

19. The system of claim 17, wherein the program instructions are executable to:
retrieve image information based on image name and/or tag;
handle environment variables; and
compute a hash value for a command, the image information, and the environment variables.

20. The system of claim 17, wherein the program instructions are executable to:
update the results of the pipeline based on template results of the template pipeline.
